(19) United States
(12) Patent Application Publication
(10) Pub. No.: US 2005/0116372 A1
(43) Pub. Date: Jun. 2, 2005

(54) Composite material and method for its production

(76) Inventors: Jurgen Bruning, Werther (DE); Ekkehard Labizke, Koditz (DE); Maik Ziegler, Grafenhain (DE); Matthias Meimberg, Gotha (DE)

Correspondence Address: Frost Brown Todd LLC, 2200 PNC Center, 201 East Fifth Street, Cincinnati, OH, 45202, US

(21) Appl. No.: 10/610,035

(22) Filed: Jun. 30, 2003

(30) Foreign Application Priority Data
Jul. 1, 2002 (DE) 10229725.8

(51) Int. Cl. B29C 44/00

(52) U.S. Cl. 264/45.3

(57) ABSTRACT

A composite material constituting foam particles and fibers, comminuted materials, or a combination thereof. They composite material may be manufactured by mixing the components prior to molding or mixing the components as they introduced into the mold. Heat may be used to weld the components together to form the composite material. Additionally, the composite material may also include reinforcement agents, adhesive agents, films or combinations thereof.

### BRIEF SUMMARY

The invention concerns a method for the production of components made of foam particles in conjunction with fibers and/or subsequently comminuted granule material and/or nonwoven materials, which preferably are used for molded articles, plane articles, or intermediate products with increased demands with regard to acoustics, strength, and energy absorption, such as for insulation, packagings, roof or floor foundations, door inserts, but also as crash pads.

Hereby, foam particles, preferably EPP (expanded polypropylene particle foam), EPS (expanded polystyrene particle foam), EPE (expanded polyethylene particle foam), or foam particles which are obtained by comminution of crosslinked or noncrosslinked (XPP) polyolefin foam films or plates, together with fibers, granule material or, in layers, with nonwoven materials, are sensibly and at low cost processed to form a molded plane article. They are produced both as a semifinished product and are subsequently processed, or processed together with others in a molded article machine as a semifinished product or made into a molded article from several components, such as EPP fiber-granule-nonwoven, in one operation, under the influence of hot air/steam in the machine.

The method in accordance with the invention combines several production operations in one; great value was also placed on acoustics, purity of type, and in particular, cost.

The processing can take place in a traditional molded article process in a molded article machine, wherein the foam particles, granules are initially premixed with fibers or separately added, via injectors, to the molded article mold. Furthermore, a processing of the foam particles, fibers, and granules to form a molded plane article and semifinished product to form a molded article can be carried out via a method which differs from the molded article process.

### BRIEF DESCRIPTION OF THE DRAWINGS

FIG. 1 depicts an initial set-up for one exemplary embodiment of the present invention.

FIG. 2 depicts the completion of the exemplary embodiment depicted in FIG. 1.

FIG. 3 depicts an initial set-up for a second exemplary embodiment of the present invention.

FIG. 4 depicts the completion of the exemplary embodiment depicted in FIG. 3.

### DETAILED DESCRIPTION OF THE INVENTION

The invention concerns a method for the production of components from particle foams, in conjunction with fibers and/or granules, by mixing the foam particles, granules with fibers and introducing them into the mold via filling injectors or by the separate addition of the foam particles, granules, and fibers into a mold and a subsequent combination of the components to form a molded article via a traditional molded article process or a process which differs from it.

The processing of foam particles using hot vapor in molded article machines to form molded articles is known. These molded articles can be modified by the refoaming of insertion parts, covering with films or textiles for their individual application cases.

The characteristics of molded articles from particle foams are attained, as a rule, by their construction design, material density, or a combination with cover layers or insertion parts. Another possibility is to be found in the formation of a material composite, by refoaming, in-mold skinning, or the subsequent covering of the foam parts.

Patents DE 4312517 and DE 19544451 describe a foam part, combined with a reinforcement mat, fabric, nonwoven, to lower the tear sensitivity of the component. Frequently, composite structures are also built from foam materials in connection with cover layers, in which foam particles are welded in the molded article process with hot vapor, as, for example, in DE 100 03 595 A. In EP 1077 127, a composite material is described which is built with a natural fiber mat permeated with foamable and/or curable materials.

In Patent DE 19641944, rod elements are integrated into the foam molded article in the molded article process for the improvement of energy absorption, in order to optimize the rigidity and the energy absorption capacity to the individual application case. DE 3345408 and DE 4432082 describe components consisting of foam elements with different densities, so as to purposefully adjust the characteristics of the component in this way.

Foam parts which are to be optimized with regard to their characteristics are frequently produced with great effort and cost-intensively with respect to process technology. The production of molded articles from particle foam materials, such as EPP, takes place via the production of the foam beads by means of the autoclave or extrusion processes, the welding of PP foam particles in the molded article process by means of hot vapor, which is expensive with regard to energy, and the subsequent tempering. The covering with a decorative film or with a textile also requires process steps. Methods for reinforcement by cover layers, which are in-mold skinned, or insertion parts, which are refoamed, bring, above all, a limited adhesion of the material composite, in addition to the considerable lack of process reliability, and frequently the welding and thus the adhesion of the particles to one another are insufficient.

The goal of the invention therefore is to produce in an economic process, the production of components from particle foam with substantially improved adhesion of the used components and defined characteristics of acoustics, strength, and handling predominantly.

This is attained in that foam particles, fibers, and subsequently comminuted granules are introduced into a mold and are combined to form molded articles, wherein via the size, the type, and the fraction of the fibers and granules, the molded article characteristics are decisively determined. EP (expanded polypropylene particle foam), EPS (expanded polystyrene particle foam), or EPE (expanded polyethylene particle foam) are preferably used as foam particles. Natural, synthetic, mineral, and recycling fibers, either alone or as a mixture thereof, can be used as fibers. As subsequently comminuted granules, production residue substances from the carpet industry or from a take-back agreement, which are brought to a defined particle size, can be used alone or in a mixture with fibers and/or foam particles. For the substantial improvement of the foam particles-fibers and granules adhesion, purity of type and/or CO-polymer fibers with a corresponding length, curling, and strength (DTEX) are used. The foam particles, fibers, and granules are mixed and introduced into a mold or introduced into a mold by metering via separate filling systems.

The molded article production can, on the one hand, take place in a traditional molded article process via welding by means of hot vapor, wherein molds are used which are made of a porous material or are perforated or are provided with vapor nozzles. Moreover, methods which differ from the traditional molded article process can be used, such as the welding of the foam particle-fiber and granule mixture via microwave energy, by means of infrared radiation, by introduction of adhesive agents/adhesives, hot air, and/or in pressing or thermoforming methods. One variant is also the production of individual layers which are joined to form a molded article, and subsequently or during the combining of the fibers and foam particles, are reshaped via pressing or thermoforming processes. Another variant is the combination with insertion parts, nonwovens, textiles, films. Via the fibers, an additional bonding of these insertion parts, nonwovens, textiles, and films to the foam particles can be attained. The bonding of the fibers to the foam particles and perhaps, insertion parts, nonwovens, textiles, and films can be material-, form-, or force-locking. A material-locking union can be attained with synthetic fibers or fibers with a copolymer fraction or with polymer, coated fibers. The use of intermediate layers in the foam material or the granule part, in the form of nonwovens, films, or textiles, which consist of the same polymers or copolymers, or can additionally be furnished with polymers, adhesives or resins, make possible an additional molded article reinforcement and absorber tasks. Likewise, the use of glass fiber nonwovens or supports, in combination with individual glass fibers, is possible.

A substantial advantage of the method is the production of foam material composites which can be produced in one method step and whose characteristics can be purposefully adjusted by the type and size and fraction of the fibers and granules. Another advantage of the use of fibers is an improved combination of the foam material particles with one another via the fibers and granules and a bonding of the foam particles via the fibers to insertion parts, films, nonwovens, fabrics, or textiles. The bonding, adhesion, and thus the force transfer of these components to the foam particles is considerably improved via the fibers, which, on the one hand, makes possible the construction of high-strength components, and on the other hand, does not in any way neglect the acoustics in the deep, middle, and high-frequency range. Depending on the product and use, the acoustics, which are so often neglected, can be controlled.

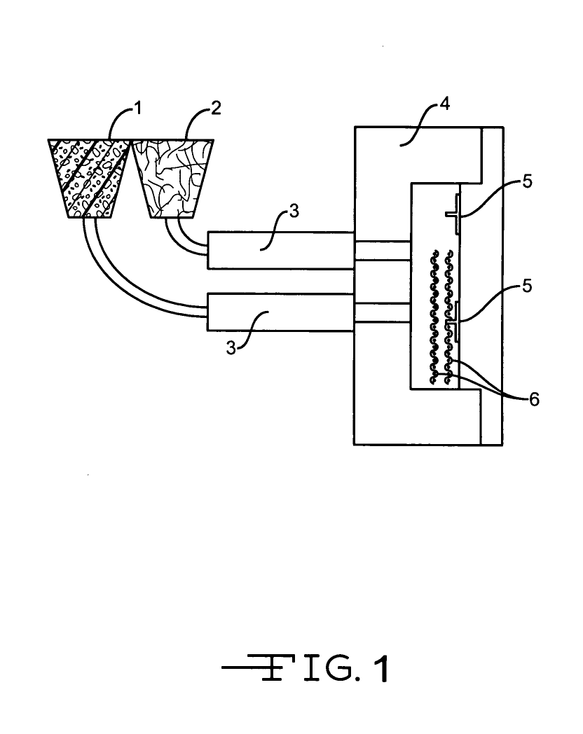

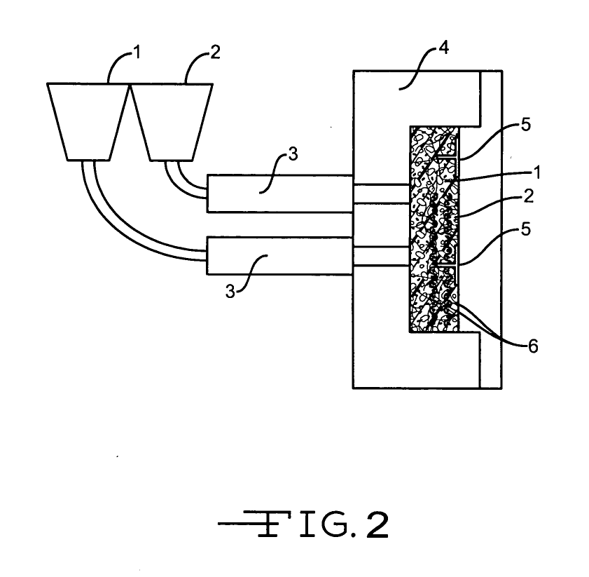

FIG. 1 and FIG. 2 depict an exemplary embodiment of the present invention wherein foam particles (2) and fibers (1) are conveyed to a mold (4), via metering devices (3), and are welded there to form molded articles. The foam particles are conveyed by compressed air, wherein the starting materials (1,2) are conveyed against a counterpressure in the mold (4). The combining or welding of the bed of fibers (1) and foam particles (2) can take place by means of hot vapor or radiation energy. In addition, insertion parts (5) or fiber mats (6) can be integrated into the molded article process and a binding of these components (5,6) to fibers (1) and foam material (2) can take place.

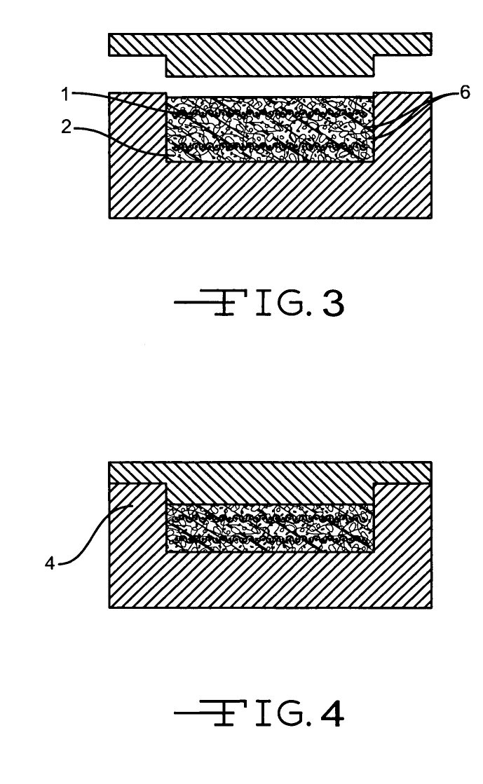

FIG. 3 and FIG. 4 depict yet another exemplary embodiment of the present invention wherein foam particles (2) and fibers (1) are conveyed to a mold (4) and are welded there to form molded articles. The conveyance of the foam particles can take place via metering devices or manually. In a second step, the mixture of fibers (1) and foam particles (2) is compressed mechanically via the mold halves (4) and/or pneumatically and welded via hot vapor, radiation energy, or another type of heat supply, to form a molded article. In addition, insertion parts or fiber mats (6) can be integrated into the molded article process and a bonding of these components (6) to the fibers (1) and foam (2) can take place.

The following graph depicts the absorption factor of a composite material embodying the present invention consisting of glass fiber and EPP compared to the absorption factor of EPP particle foam (30 kg/m³ and 40 kg/m³):

[image]

1. Method for the production of molded and plane articles from foam particles and/or fibers and/or subsequently comminuted material/granules and/or comminuted films, characterized in that the components are introduced into a mold and a composite material is produced by combining these components.

2. Method according to claim 1, characterized in that expanded polypropylene particles (EPP), expanded polyethylene particles (EPE), or expanded polystyrene particles (EPS), or foam particles, which, by means of comminuting crosslinked and noncrosslinked (XPP) polyolefin foam films or plates, are used as foam particles.

3. Method according to one or more of the preceding claims, characterized in that all of the components or individual components are recycled materials.

4. Method according to one or more of the preceding claims, characterized in that natural, mineral, synthetic fibers or fibers or copolymers, coated with a polymer, or a combination of different fiber types are used.

5. Method according to one or more of the preceding claims, characterized in that the length of the fibers is between 1 mm and 150 mm.

6. Method according to one or more of the preceding claims, characterized in that the fibers have a curling which is between 1 and 10 curves per 1 cm.

7. Method according to one or more of the preceding claims, characterized in that the fibers are slender.

8. Method according to one or more of the preceding claims, characterized in that subsequently comminuted material/granules, mainly consisting of polymers and fillers, are present.

9. Method according to one or more of the preceding claims, characterized in that the particle size of the granules is between 1 mm and 150 mm.

10. Method according to one or more of the preceding claims, characterized in that all components can be mixed with one another in arbitrary weight-percent fractions.

11. Method according to one or more of the preceding claims, characterized in that these raw materials are introduced separately into the mold.

12. Method according to one or more of the preceding claims, characterized in that these raw materials are introduced, mixed, into the mold.

13. Method according to one or more of the preceding claims, characterized in that a layered structure is built from a foam particle-fiber mixture and/or granules and/or nonwovens and/or textiles and/or films.

14. Method according to one or more of the preceding claims, characterized in that these nonwovens, textiles, or films lie, as reinforcement and absorbers, between the foam particle-fiber mixture and granules.

15. Method according to one or more of the preceding claims, characterized in that these nonwovens, textiles, or films lie, as reinforcement and adhesive agents, between the foam particle-fiber mixture and/or between the granules, and can act as absorbers.

16. Method according to one or more of the preceding claims, characterized in that the foam particle-fiber-granule composite is covered with a cover layer and this cover layer consists of
a TPO film,
a TPO film with a foam backing,
a textile,
a textile with a foam backing,
natural fibers,
glass fibers,
a hybrid fabric consisting of glass fibers and polymer fibers, or
a hybrid fabric consisting of natural fibers and polymer fibers.

17. Method according to one or more of the preceding claims, characterized in that insertion parts are also introduced into the foam material composite.

18. Method according to claim 17, characterized in that insertion parts are heated before and during the process.

19. Method according to claim 17, characterized in that these insertion parts are used to stiffen the foam material composite.

20. Method according to claim 17, characterized in that these insertion parts contain functional elements, such as holders, hinges, mirror lids, and plate bars.

21. Method according to one or more of the preceding claims, characterized in that the contact surfaces of the materials to be joined are provided with adhesive agents or adhesives.

22. Characterized in that the material composite is combined thermally in a porous, perforated, or hole-punched mold by means of hot air, to form a plane or molded article.

23. Method according to one or more of the preceding claims, characterized in that the fibers, granules, and foam particles are welded to form a molded article in a porous or perforated mold or one provided with vapor nozzles, by means of hot vapor.

24. Method according to one or more of the preceding claims, characterized in that the fibers, granules, and foam particles are welded in a mold by means of high-frequency radiation, to form a molded article.

25. Method according to one or more of the preceding claims, characterized in that the fibers, granules, and foam particles are welded in a mold by means of infrared radiation, to form a molded article.

26. Method according to one or more of the preceding claims, characterized in that the mold is made of a resin or metal, which is perforated.

27. Method according to one or more of the preceding claims, characterized in that the material composite is produced continuously by a continuous method.

28. Method according to one or more of the preceding claims, characterized in that the material composite is reshaped during or after the welding.

29. Method according to one or more of the preceding claims, characterized in that the materials to be reshaped are heated to a temperature of 100-250° C.

30. Composite material and material composite and products which are produced according to one or more of the preceding claims.

31. Composite material and material composite and products which are produced according to one or more of the preceding claims are characterized in that they are floor or roof layers in the household or automobile sector.
